(19) United States
(12) Patent Application Publication
(10) Pub. No.: US 2018/0319048 A1
(43) Pub. Date: Nov. 8, 2018

(54) MOLDING DEVICE HAVING HEATING FUNCTION

(71) Applicant: POU CHEN CORPORATION, Chang Hwa Hsien (TW)

(72) Inventors: Hsiang-Yu HUANG, Taichung City (TW); Shih-Chia LIN, Yuanlin City (TW); Hung-Wu HSIEH, Xizhou Township (TW); Ju-Cheng CHEN, Tainan City (TW); Tsung-Wei KUO, Changhua City (TW)

(21) Appl. No.: 15/968,523

(22) Filed: May 1, 2018

(30) Foreign Application Priority Data
May 3, 2017 (TW) 106114629

(51) Int. Cl. B29C 43/50; B29C 43/36; B29C 43/02

(52) U.S. Cl. CPC B29C 43/50; B29K 2105/04; B29C 43/02; B29C 43/36

(57) ABSTRACT

A molding device includes lower and upper die core assemblies. The lower die core assembly includes at least two lower die core units surrounding a central axis and defining a mold cavity. The lower die core assembly is convertible between an open state and a closed state. When converted from the closed state into the open state, the lower die core units are moved away from the central axis. When converted from the open state into the closed state, the lower die core units are moved toward the central axis to compress the foaming material. The upper die core assembly is convertible between a lifted state, where the upper die core assembly is spaced apart from the lower die core assembly, and a lowered state to cover the mold cavity.

### CROSS-REFERENCE TO RELATED APPLICATION

This application claims priority of Taiwanese Invention Patent Application No. 106114629, filed on May 3, 2017.

### FIELD

The disclosure relates to a molding device, and more particularly to a molding device having heating function for heating and molding a foaming material into a foam object.

### BACKGROUND

Ethylene-vinyl acetate (EVA) foam material or thermoplastic polyurethane (TPU) foam material are widely used in making insole or outsole of shoes because of their superior cushion, shock-absorbing, heat insulation, moistureproof, chemical resistant properties. EVA and TPU are also nontoxic and non-water absorbing, which is quite environment friendly.

For the current EVA or TPU foaming materials, a foaming process and a heat molding process need to be conducted to obtain products. However, it is quite difficult to control the foaming rate and hardness of the foaming materials, thereby resulting in difficulties in obtaining both satisfactory size and hardness.

Referring to FIG. 1, a conventional heat molding process includes manually putting a foaming raw material 1 undergoing the foaming process, which has a larger volume, into a mold cavity 21 of a mold 2, and subsequently heating the foaming raw material 1 to obtain a product with desired size and physical strength.

However, the product in the mold cavity 21 needs to be manually removed. This manual removal process not only requires extra manpower but also make it to be possible to damage the product.

### SUMMARY

Therefore, an object of the disclosure is to provide a molding device that can alleviate the drawback of the prior art.

The molding device is adapted to heat and mold a foaming material into a foam object. The molding device includes a lower die core assembly and an upper die core assembly.

The lower die core assembly includes at least two lower die core units that surround a central axis and that cooperatively define a mold cavity. The lower die core assembly is convertible between an open state and a closed state. When the lower die core assembly is converted from the closed state into the open state, the lower die core units are moved away from the central axis such that the mold cavity is expanded so as to allow the forming material to be placed into the mold cavity. When the lower die core assembly is converted from the open state into the closed state, the lower die core units are moved toward the central axis to compress the foaming material.

The upper die core assembly is convertible between a lifted state, where the upper die core assembly is spaced apart from the lower die core assembly, and a lowered state, where the upper die core assembly is in contact with the lower die core assembly to cover the mold cavity.

### BRIEF DESCRIPTION OF THE DRAWINGS

Other features and advantages of the disclosure will become apparent in the following detailed description of the embodiment and variations with reference to the accompanying drawings, of which:

FIG. 1 is a schematic view of a conventional heat molding apparatus;

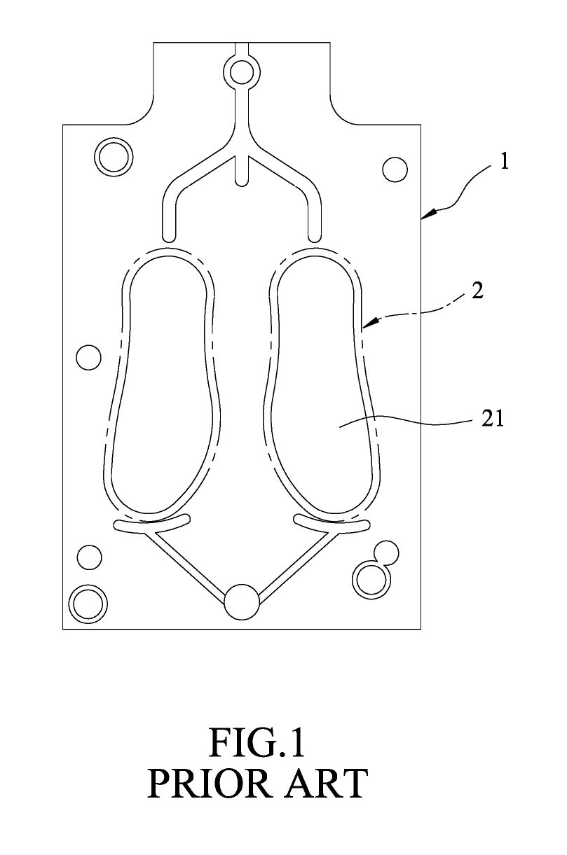

FIG. 2 is a partly exploded perspective view of an embodiment of a molding device according to the present disclosure;

FIG. 3 is a partly exploded perspective view of the embodiment, omitting an upper die core assembly of the embodiment;

FIG. 4 is a top view of the embodiment;

FIG. 5 is a sectional view of the embodiment taken along line V-V in FIG. 4, showing a lower die core assembly of the embodiment being in a closed state, and the upper die core assembly being in a lowered state;

FIG. 6 is a sectional view of the embodiment taken along line VI-VI in FIG. 4, showing the lower die core assembly being in an open state and the upper die core assembly being in a lifted state;

FIG. 7 is a partly sectional top view of the embodiment, showing a foaming material placed in a mold cavity of the embodiment, and the lower die core assembly being in the open state;

FIG. 8 is a schematic sectional view illustrating how the upper die core assembly is converted from the lifted state into the lowered state;

FIG. 9 is a sectional view of the embodiment, showing the lower die core assembly being in the closed state, and the upper die core assembly being in the lowered state;

FIG. 10 is a partly sectional top view of the embodiment, showing the foaming material placed in the mold cavity, and the lower die core assembly being in the closed state to compress the foaming material;

FIG. 11 is a sectional view of a variation of the embodiment; and

FIG. 12 is a partly sectional top view of another variation of the embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

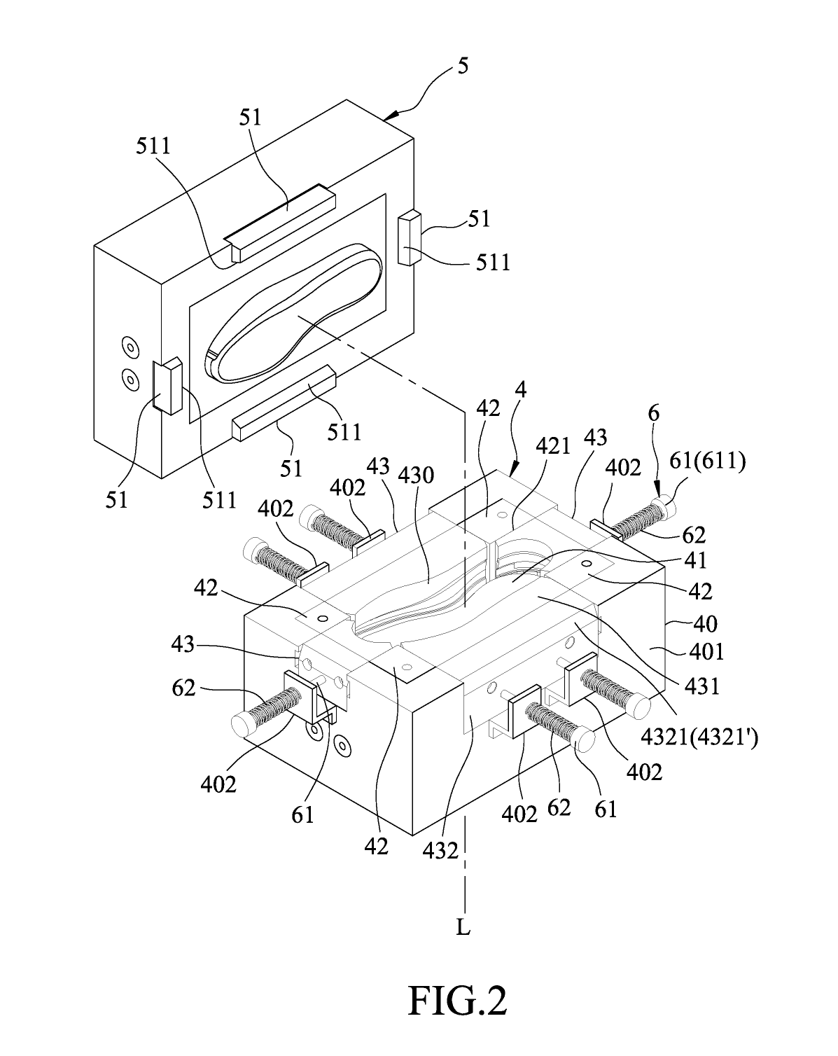

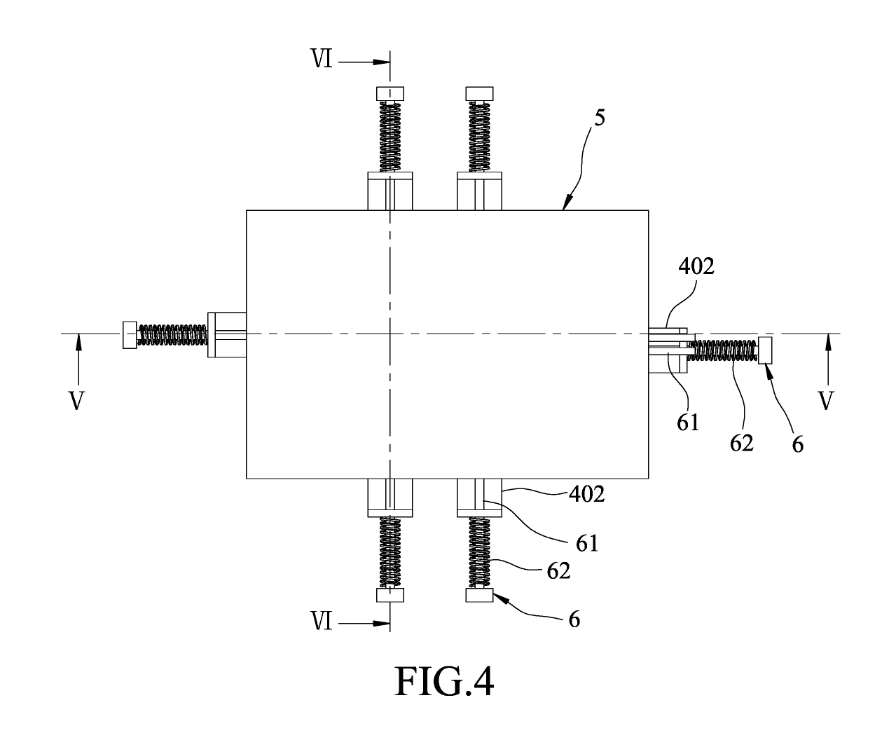

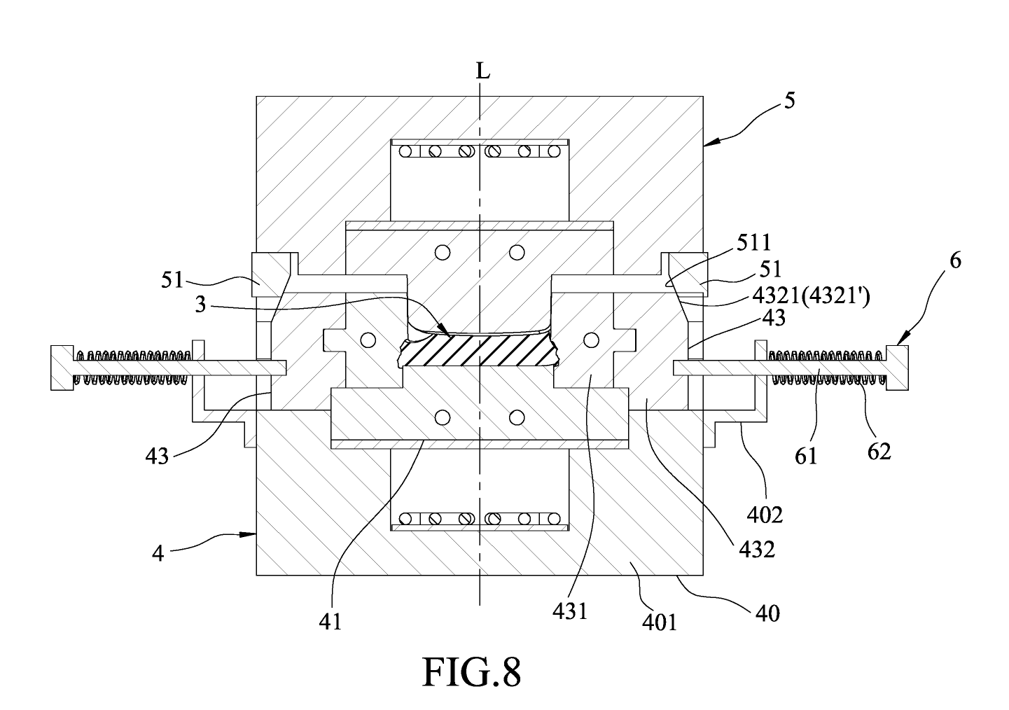

Referring to FIGS. 2 to 4, an embodiment of a molding device according to the present disclosure is adapted to heat and mold a foaming material 3 (see FIG. 8) into a product, such as a foam object. The molding device includes a lower die core assembly 4, an upper die core assembly 5 and a biasing assembly 6.

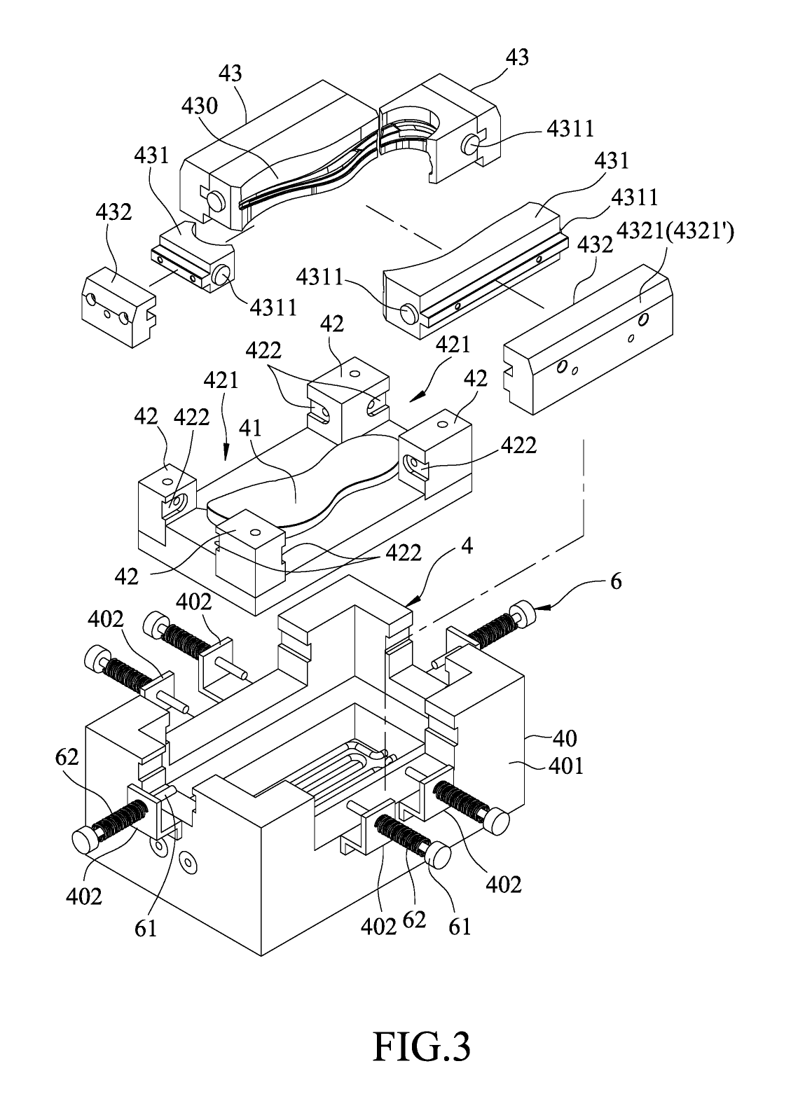

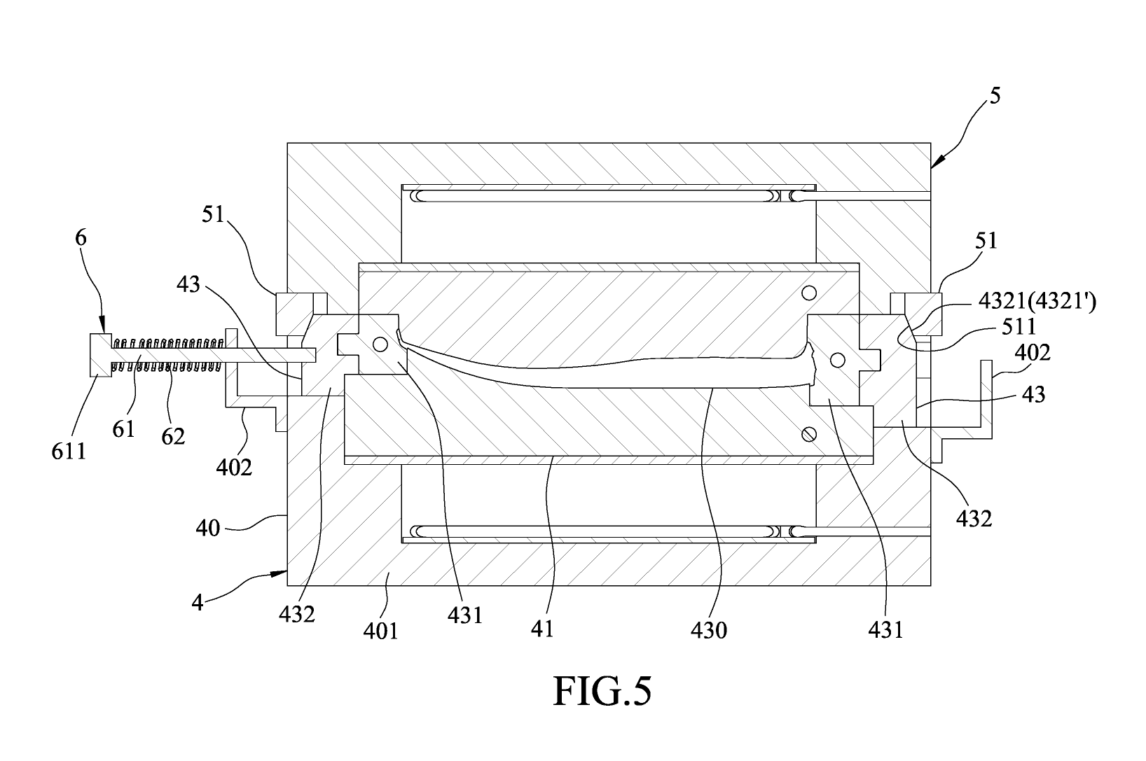

Referring to FIGS. 3 and 5, the lower die core assembly 4 includes a lower mold seat 40, a mold plate 41 that is mounted in the lower mold seat 40, four positioning blocks 42 that are fixedly disposed on the mold plate 41 and that are spaced apart from each other, and at least two lower die core units 43. In this embodiment, the lower die core assembly 4 includes four of the lower die core units 43.

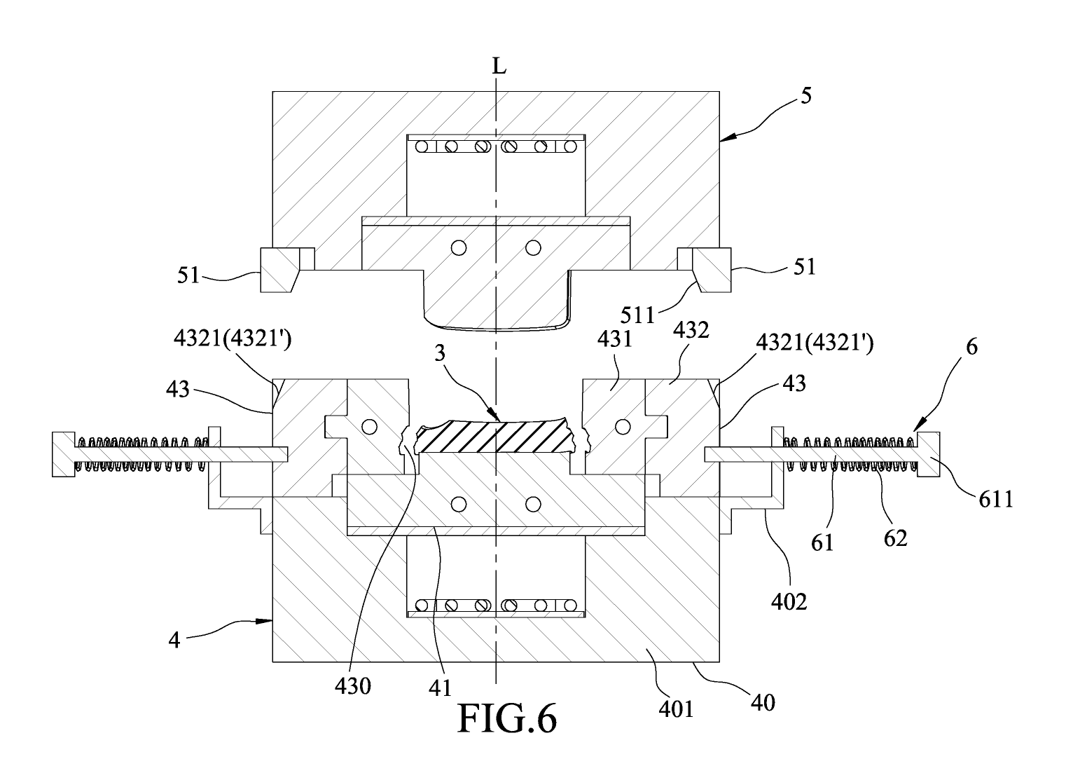

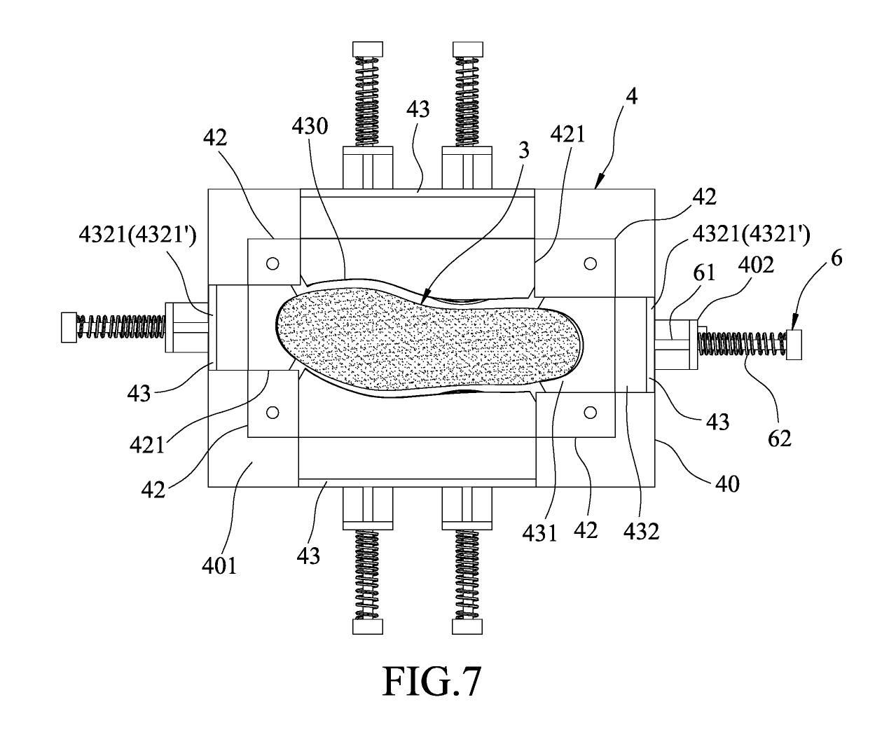

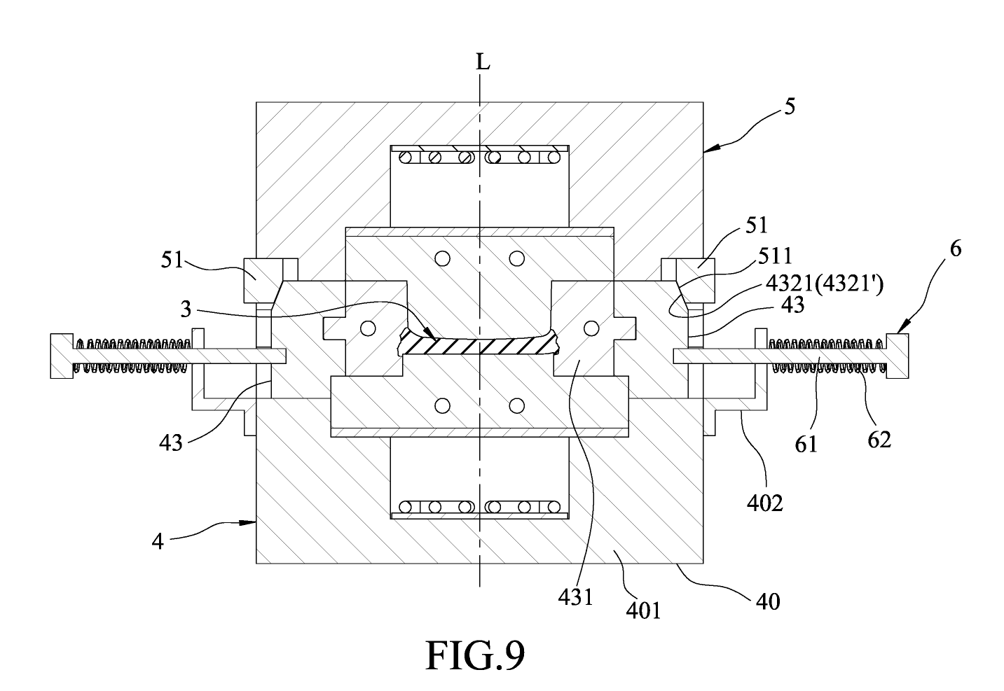

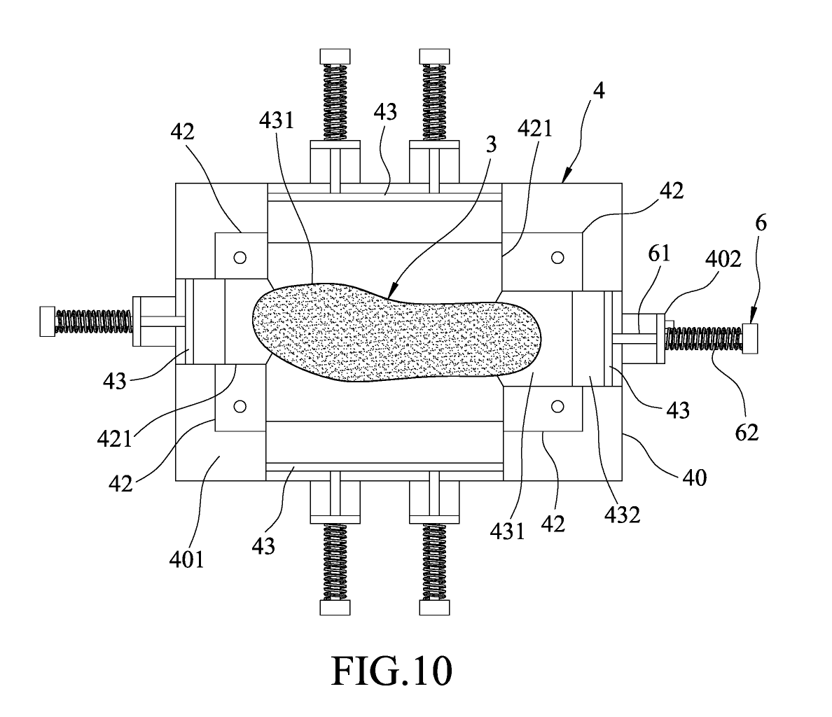

The lower mold seat 40 includes a main body 401 and three pairs of brackets 402 that are mounted to the main body 401. Referring to FIG. 3, in this embodiment, one pair of the brackets 402 are respectively mounted to opposite front and rear sides of the main body 401, and the remaining two pairs of the brackets 402 are respectively mounted to opposite left and right sides of the main body 401. The positioning blocks 42 cooperatively define two passages 421 that respectively extend in a front-and-rear direction, which is parallel to a longitudinal side of the main body 401 of the lower mold seat 40, and a left-and-right direction, which is parallel to a transverse side of the main body 401 of the lower mold seat 40 and which is perpendicular to the front-and-rear direction. Each of the positioning blocks 42 is formed with two slide slots 422 respectively communicated with the passages 421 and each having an open end and a closed end (see FIG. 3). The lower die core units 43 are movably disposed on the mold plate 41, surround a vertical central axis (L), and cooperatively define a mold cavity 430 adapted for receiving the foaming material 3. Each of the lower die core units 43 is movable in a corresponding one of the passages 421. Each of the lower die core units 43 includes a die core 431 and a sliding block 432 that is co-movably connected to the die core 431. The die core 431 of each of the lower die core units 43 includes two protrusions 4311, each of which slidably engages a corresponding one of the slide slots 422 of an adjacent one of the positioning blocks 42. The sliding block 432 of each of the lower die core units 43 has an engaging portion 4321 that is disposed at an upper end thereof. The lower die core assembly 4 is convertible between an open state (see FIGS. 6 and 7) and a closed state (see FIGS. 9 and 10). When the lower die core assembly 4 is converted from the closed state into the open state, the lower die core units 43 are moved away from the central axis (L) such that the mold cavity 430 is expanded so as to allow the foaming material 3 to be placed into the mold cavity 430. When the lower die core assembly 4 is converted from the open state into the closed state, the lower die core units 43 are moved toward the central axis (L) to compress the foaming material 3. In this embodiment, the engaging portion 4321 of the sliding block 432 of each of the lower die core units 43 is a first beveled surface 4321′ that is slanted away from the central axis (L).

Referring to FIGS. 2, 4 and 5, the upper die core assembly 5 is convertible between a lifted state (see FIG. 6), where the upper die core assembly 5 is spaced apart from the lower die core assembly 4, and a lowered state (see FIG. 9), where the upper die core assembly 5 is in contact with the lower die core assembly 4 to cover the mold cavity 430. The upper die core assembly 5 includes at least two engaging members 51. In this embodiment, the upper die core assembly 5 includes four of the engaging members 51, and each of the engaging members 51 corresponds in position to the engaging portion 4321 of the sliding block 432 of a respective one of the lower die core units 43 along a direction parallel to the central axis (L). When the upper die core assembly 5 is in the lifted state, each of the engaging members 51 is spaced apart from the engaging portion 4321 of the respective one of the lower die core units 43. When the upper die core assembly 5 is converted from the lifted state into the lowered state, each of the engaging members 51 moves to contact and push the engaging portion 4321 of the respective one of the lower die core units 43 toward the central axis (L) until a bottom surface of the upper die core assembly 5 abuts against a top surface of the lower die core assembly 4, so that the lower die core assembly 4 is converted from the open state into the closed state and kept in the closed state. Specifically, in this embodiment, each of the engaging members 51 of the upper die core assembly 5 is a second beveled surface 511 that is parallel to and abuts against the first beveled surface 4321′ of the respective one of the lower die core units 43 to keep the lower die core assembly 4 in the closed state when the upper die core assembly 5 is in the lowered state.

The biasing assembly 6 includes a plurality of sliding members 61 and a plurality of resilient members 62. Specifically, in this embodiment, the number of the sliding members 61 is six and the number of the resilient members 62 is also six. Each of the sliding members 61 has a head portion 611, movably extends through a corresponding one of the brackets 402 of the lower mold seat 40, and is fixedly connected to the sliding block 432 of a corresponding one of the lower die core units 43. Each of the resilient members 62 is configured as a compression spring and is disposed between the head portion 611 of a corresponding one of the sliding members 61 and the corresponding one of the brackets 402, and continuously exerts a biasing force to push the corresponding one of the lower die core units 43 connected to the corresponding one of the sliding members 61 away from the central axis (L). It is worth mentioning that the numbers of the sliding members 61 and the resilient members 62 are not limited to six, and may be changed according to practical requirements.

Referring to FIGS. 6 and 7, when the upper die core assembly 5 is in the lifted state, the engaging members 51 are spaced apart from the engaging portions 4321 of the lower die core units 43. In this state, the biasing force of the resilient members 62 is applied to the sliding members 61 to push the sliding members 61 and the lower die core units 43 connected thereto to move away from the central axis (L), thereby expanding the mold cavity 430 and allowing an automated apparatus (not shown) to easily remove the product from the mold cavity 430.

Referring to FIGS. 8 to 10, when the upper die core assembly 5 is moved from the lifted state to the lowered state, the second beveled surface 511 of each of the engaging members 51 moves to contact and push the engaging portion 4321 of the sliding block 432 of the respective one of the lower die core units 43, allowing the lower die core units 43 to overcome the biasing force of the resilient members 62 and being moved toward the central axis (L) to compress the foaming material 3.

In the lowered state, the second beveled surface 511 of each of the engaging members 51 abuts against the engaging portion 4321 of the sliding block 432 of the respective one of the lower die core units 43, and the lower die core assembly 4 is maintained in the closed state.

Referring to FIGS. 6 and 7, after heating and compression of the foaming material 3, the upper die core assembly 5 is converted to the lifted state, where the engaging members 51 are spaced apart from the lower die core units 43, allowing the biasing force of the resilient members 62 to push the sliding members 61 and the lower die core units 43 away from the central axis (L), thereby expanding the mold cavity 430.

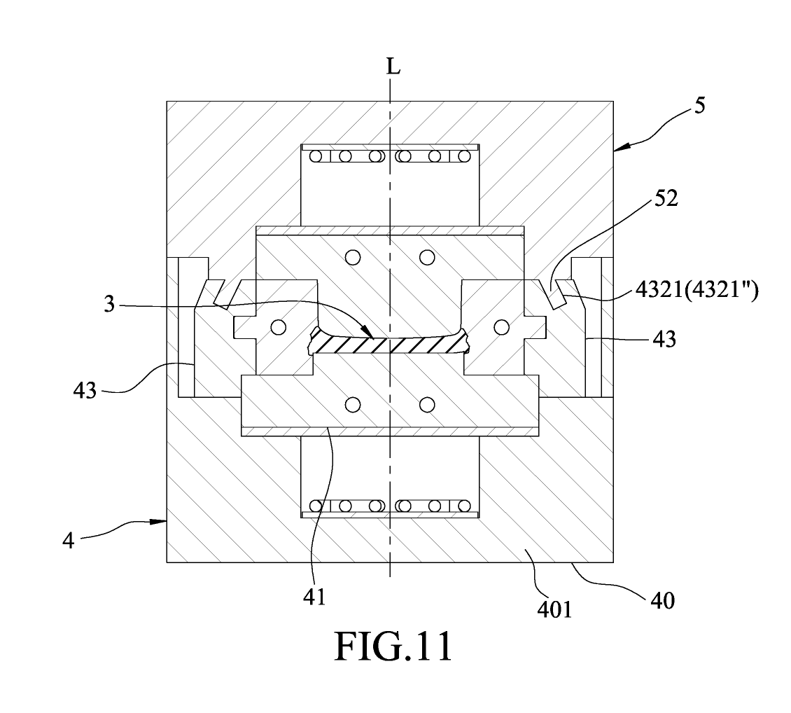

Referring to FIG. 11, a variation of the embodiment of the molding device is described hereinafter.

In the variation, the engaging portion 4321 of the sliding block 432 of each of the lower die core units 43 is a slanted groove 4321″ that is slanted away from the central axis (L), and each of the engaging members 51 of the upper die core assembly 5 is a projection 512 that is parallel to the slanted groove 4321″ and that extends into the slanted groove 43211″ of the sliding block 432 of the respective one of the lower die core units 43 when the upper die core assembly 5 is in the lowered state, allowing the lower die core units 43 to overcome the biasing force of the resilient members 62 and to be moved toward the central axis (L) to compress the foaming material 3.

It is worth mentioning that the biasing assembly 6 may be provided to the variation according to actual requirements.

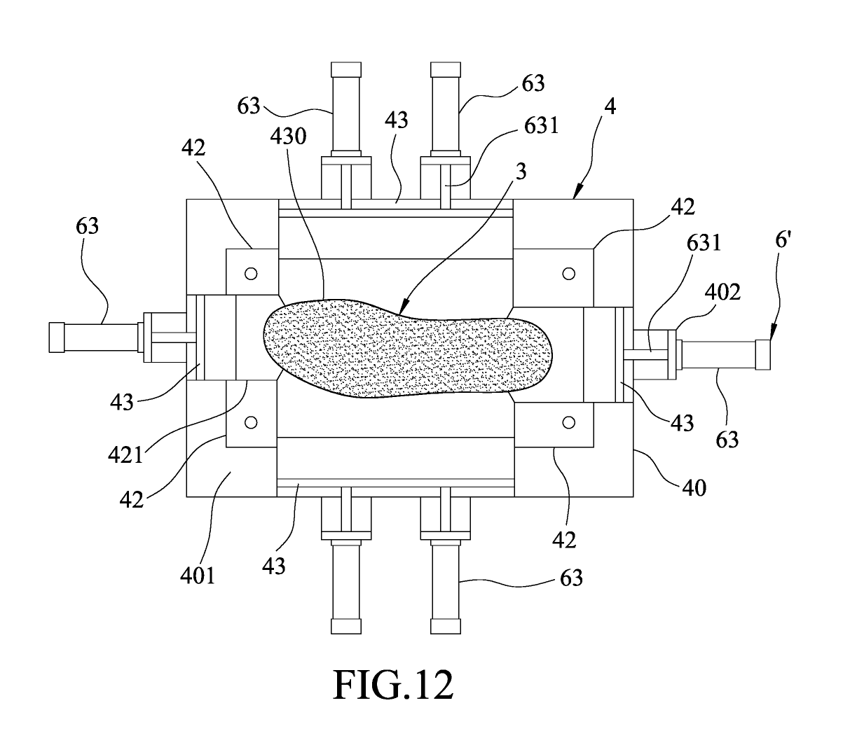

Referring to FIG. 12, another variation of the embodiment of the molding device is described hereinafter.

In the another variation, the engaging portion 4321 of the sliding block 432 of each of the lower die core units 43 and the engaging members 51 of the upper die core assembly 5 are omitted, and a driving assembly 6′ is added. The driving assembly 6′ includes a plurality of driving cylinders 63. Each of the driving cylinders 63 is mounted to the lower mold seat 40, and includes a cylinder shaft 631 (i.e., piston rod) that movably extends into the lower mold seat 40 and is fixedly connected to a corresponding one of the lower die core units 43. Each of the driving cylinders 63 is operable to move the corresponding one of the lower die core units 43 on the lower mold seat 40 so as to convert the lower die core assembly 4 between the closed state and the open state.

It is worth mentioning that the mold plate 41 and the die core 431 of each of the lower die core units 43 may be replaced with a new one of different size when the lower die core assembly 4 is in the open state, for accommodating different sizes of the foaming material 3.

The advantages of the molding device according to the present disclosure are summarized below.

The lower die core units 43 define the mold cavity 430 that can be expanded or contracted, facilitating insertion or removal of the foaming material 3 and providing uniform compression of the foaming material 3. The quality of the product can be further improved by cooperation with the automated apparatus for removing the foaming material 3.

The mold plate 41 and the die core 431 of each of the lower die core units 43 may be changed without changing the lower mold seat 40 and the biasing assembly 6, 6′ based on the sizes of the foaming material 3.

In the description above, for the purposes of explanation, numerous specific details have been set forth in order to provide a thorough understanding of the embodiment and variations. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiment and variations, it is understood that this disclosure is not limited to the disclosed embodiment and variation but is intended to cover various arrangements included within the spirit and scope of the broadest interpretation so as to encompass all such modifications and equivalent arrangements.

What is claimed is:

1. A molding device adapted to heat and mold a foaming material into a foam object, said molding device comprising:
a lower die core assembly including at least two lower die core units that surround a central axis and that cooperatively define a mold cavity, said lower die core assembly being convertible between an open state and a closed state such that, when said lower die core assembly is converted from the closed state into the open state, said lower die core units are moved away from the central axis such that said mold cavity is expanded so as to allow the foaming material to be placed into said mold cavity, and when said lower die core assembly is converted from the open state into the closed state, said lower die core units are moved toward the central axis to compress the foaming material; and
an upper die core assembly being convertible between a lifted state, where said upper die core assembly is spaced apart from said lower die core assembly, and a lowered state, where said upper die core assembly is in contact with said lower die core assembly to cover said mold cavity.

2. The molding device as claimed in claim 1, wherein:
each of said lower die core units has an engaging portion, said upper die core assembly including at least two engaging members;
when said upper die core assembly is in the lifted state, each of said engaging members is spaced apart from said engaging portion of a respective one of said lower die core units;
when said upper die core assembly is converted from the lifted state into the lowered state, each of said engaging members moves to contact and push said engaging portion of the respective one of said lower die core units to move the respective one of said lower die core units toward the central axis such that said lower die core assembly is converted from the open state into the closed state and kept in the closed state.

3. The molding device as claimed in claim 2, wherein:
said engaging portion of each of said lower die core units is a first beveled surface that is slanted away from the central axis; and
each of said engaging members of said upper die core assembly is a second beveled surface that is parallel to and abuts against said first beveled surface of the respective one of the lower die core units when said upper die core assembly is in the lowered state.

4. The molding device as claimed in claim 2, wherein:
said engaging portion of each of said lower die core units is a slanted groove that is slanted away from the central axis; and
each of said engaging members of said upper die core assembly is a projection that is parallel to said slanted groove and that extends into said slanted groove of the respective one of said lower die core units when said upper die core assembly is in the lowered state.

5. The molding device as claimed in claim 2, further comprising a biasing assembly that includes a plurality of sliding members and a plurality of resilient members, said lower die core assembly further including a lower mold seat on which said lower die core units are movably disposed, each of said sliding members movably extending into said lower mold seat and being fixedly connected to a corresponding one of said lower die core units, each of said resilient members being disposed between a corresponding one of said sliding members and said lower mold base and pushing a corresponding one of said lower die core units connected to a corresponding one of said sliding members away from the central axis.

6. The molding device as claimed in claim 5, wherein said lower mold seat includes a main body and a plurality of brackets that are mounted to said main body, each of said sliding members movably extending through a corresponding one of said brackets, each of said resilient members being disposed between the corresponding one of said sliding members and the corresponding one of said brackets.

7. The molding device as claimed in claim 5, wherein said lower die core assembly includes four of said lower die core units, two of said lower die core units are movable in a front-and-rear direction, and the other two of said lower die core units are movable in a left-and-right direction.

8. The molding device as claimed in claim 7, wherein said lower die core assembly further includes four positioning blocks disposed on said lower mold seat, spaced apart from each other, and cooperatively defining two passages that respectively extend in the front-and-rear direction and the left-and-right direction, each of said lower die core units being movable in a corresponding one of said passages.

9. The molding device as claimed in claim 8, wherein said lower die core assembly further includes a mold plate that is mounted in said lower mold seat, said positioning blocks being disposed on said mold plate, each of said lower die core units including a die core and a sliding block that is co-movably connected to said die core, said sliding block of each of said lower die core units having said engaging portion that is disposed at an upper end thereof and being co-movably connected to the corresponding one of said sliding members.

10. The molding device as claimed in claim 1, further comprising a driving assembly that includes a plurality of driving cylinders, said lower die core assembly further including a lower mold seat on which said lower die core units are movably disposed, each of said driving cylinders being mounted to said lower mold seat and including a cylinder shaft that movably extends into said lower mold seat and is fixedly connected to a corresponding one of said lower die core units, each of said driving cylinders being operable to move the corresponding one of said lower die core units on said lower mold seat so as to convert said lower die core assembly between the closed state and the open state.
